(19) United States
(12) Patent Application Publication
(10) Pub. No.: US 2019/0317127 A1
(43) Pub. Date: Oct. 17, 2019

(54) SCANNING PROBE MICROSCOPY SYSTEM, AND METHOD FOR MOUNTING AND DEMOUNTING A PROBE THEREIN

(71) Applicant: Nederlandse Organisatie voor toegepast-natuurwetenschappelijk onderzoek TNO, s-Gravenhage (NL)

(72) Inventors: Hamed SADEGHIAN MARNANI, Den Haag (NL); Anton Adriaan BIJNAGTE, Tricht (NL); Albert DEKKER, Delft (NL)

(73) Assignee: Nederlandse Organisatie voor toegepast-natuurwetenschappelijk onderzoek TNO, 's-Gravenhage (NL)

(21) Appl. No.: 16/463,576

(22) PCT Filed: Nov. 28, 2017
(86) PCT No.: PCT/NL2017/050788

§ 371 Date: May 23, 2019

(30) Foreign Application Priority Data
Nov. 29, 2016 (EP) 16201127.4
Nov. 29, 2016 (EP) 16201131.6

(51) Int. Cl. G01Q 70/02

(52) U.S. Cl. CPC G01Q 70/02

(57) ABSTRACT

A scanning probe microscopy system (1) comprises a probe (2), a scanning head (11) having a first probe holder (21), a probe exchange manipulator (12) having a second probe holder (22), a force generating system (31, 32), and a force control system (41, 42) for controlling the force generating system to provide a resultant force (72) acting on the probe. Said resultant force comprises gas pressure force components and/or electrostatic force components. During probe-demounting or probe-mounting the probe is moving (52) from the first probe holder (21) towards the second probe holder (22), or vice versa, respectively, while neither the first probe holder nor the second probe holder is contacting the probe. Said movement of the probe is driven by said resultant force. The invention allows for automatically mounting and demounting of probes with high speed and with high accuracy.

The invention relates to scanning probe microscopy (SPM), which is a branch of microscopy that forms images of surfaces using a physical probe that scans samples. Many various established types of scanning probe microscopy exist, of which atomic force microscopy (AFM) is one of the most commonly used techniques.

In SPM systems, such as e.g. AFM systems, it is required to frequently exchange a probe, which is mounted to a scanning head of an SPM system, by another probe.

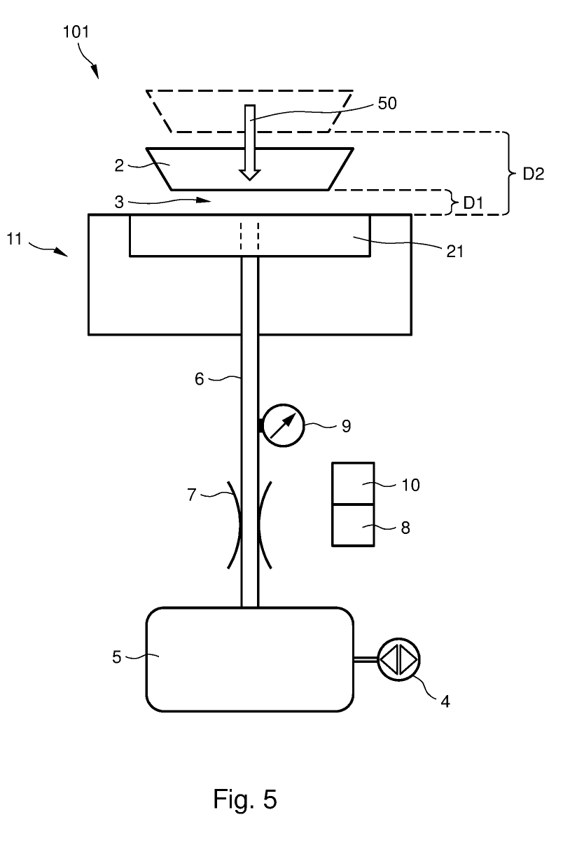

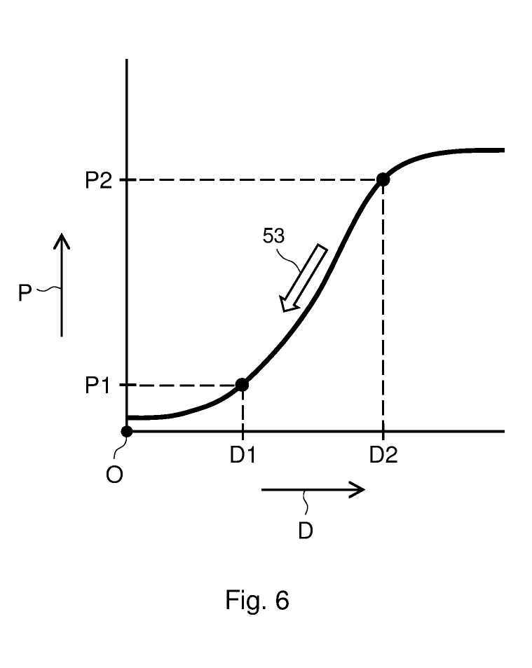

US2010/037360A1 discloses in its FIGS. 5, 6 an SPM system in which probes 560 are exchanged directly between a scanning head 510 and a probe storage device 590 based on clifferential magnetic force provided by a magnet 581 on the side of the scanning head 510 and a magnet 621 on the side of the probe storage device 590.

Also WO97/08733A1 discloses probe exchange directly between a scanning head and a probe storage device of an SPM system. In WO97/08733A1 probe exchange is performed by effecting simultaneous contact of one side of the probe with the scanning head and of the other side of the probe with the probe storage device, and by subsequently releasing one of these two contacts.

It is an object of the invention to provide a solution according to which mounting/demounting probes relative to scan heads can be automatically performed with high speed and with high accuracy.

For that purpose the invention provides a scanning probe microscopy system according to the attached independent claim 1, as well as a method according to the attached independent claim 7. Preferable embodiments of the invention are provided by the attached dependent claims 2-6 and 8-12.

Accordingly, the invention provides a scanning probe microscopy system, comprising a probe, a scanning head having a first probe holder, a probe exchange manipulator having a second probe holder, a force generating system, and a force control system for controlling the force generating system to provide a resultant force acting on the probe in the direction of the first probe holder or in the direction of the second probe holder,

wherein the probe exchange manipulator and the scanning head are movable towards and away from one another,

and wherein the scanning probe microscopy system is configured, arranged and effective to have:
a mounted-probe operation condition in which the probe is held against the first probe holder in that said force control system is controlling said resultant force to act on the probe in the direction of the first probe holder, while the probe is not contacting the second probe holder;
a demounted-probe operation condition in which the probe is held against the second probe holder in that said force control system is controlling said resultant force to act on the probe in the direction of the second probe holder, while the probe is not contacting the first probe holder;
a probe-demounting operation condition in which the scanning probe microscopy system is switching from its mounted-probe operation condition to its demounted-probe operation condition in that the probe is moving from the first probe holder towards the second probe holder, while neither the first probe holder nor the second probe holder is contacting the probe, wherein said movement of the probe from the first probe holder towards the second probe holder is driven by said resultant force acting on the probe in the direction of the second probe holder under control of said force control system; and
a probe-mounting operation condition in which the scanning probe microscopy system is switching from its demounted-probe operation condition to its mounted-probe operation condition in that the probe is moving from the second probe holder towards the first probe holder, while neither the first probe holder nor the second probe holder is contacting the probe, wherein said movement of the probe from the second probe holder towards the first probe holder is driven by said resultant force acting on the probe in the direction of the first probe holder under control of said force control system,

and wherein said resultant force comprises gas pressure force components and/or electrostatic force components.

Hence, according to the invention, in the probe-demounting operation condition and in the probe-mounting operation condition the probe is performing its transferring movements in a contactless manner in the sense that the probe neither contacts the first probe holder nor contacts the second probe holder. Thanks to this contactless character of the probe's “fly-over” movements, the mounting of the probe to the scan head and the demounting therefrom can be performed with high speed.

Furthermore, in the probe-demounting operation condition and in the probe-mounting operation condition the probe exchange manipulator and the scanning head can be arranged very close to one another in the sense that the fly-over distance over which the probe has to move during a switch between the mounted and demounted-probe operation conditions can be chosen to be very small, such as for example less than 100 micrometer, or preferably less than 20 micrometer. Such a very small fly-over distance avoids the occurrence of any substantial positioning inaccuracy during the probe's fly-over transfer. In other words, the invention allows for high accuracy in aligning the probe relative to the targeted probe holder which is to hold the probe after the probe's fly-over transfer.

It is noted that many various techniques are possible for accurately setting predetermined desirable values of the abovementioned very small fly-over distance over which the probe has to move during a switch between the mounted and demounted-probe operation conditions. For example, during setting movements of the probe exchange manipulator relative to the scanning head various distance measuring techniques can be used based on, e.g., optical principles, capacitive principles, inductive principles, fluid dynamic principles, etc., to control that a predetermined desirable value of said fly-over distance will actually be met.

As mentioned above, said resultant force comprises gas pressure force components and/or electrostatic force components. The use of gas pressure force action and/or electrostatic force action for said resultant force is highly efficient and effective to realize the abovementioned contactless character of the probe's transferring movements, especially at the abovementioned very small scales of the fly-over distances.

When performing the probe exchange operations, the probe is automatically controlled to move towards the first probe holder of the scanning head for mounting the probe to the first probe holder, or away from the first probe holder for demounting the probe from the first probe holder. It is important that these movements of the probe relative to the first probe holder are performed very fast and very accurately. To meet these speed and accuracy requirements, it is helpful to accurately measure, during these relative movements of the probe, the time-dependently variable values of a first gap width of a first gap in-between the probe and the first probe holder, especially in the movement ranges where such a first gap width is very small, such as less than 1 millimeter, less than 100 micrometer, less than 20 micrometer, and less than 10 micrometer. Based on the accurate measurements of the time-dependently variable values of a first gap width during said relative movements of the probe, probe exchange operations can generally be further optimized with respect to speed and accuracy.

However, it is noted that in SPM systems, such as e.g. AFM systems, there generally is hardly building space available for accommodating an accurate gap width measuring system of the above-explained type nearby the location where the probe and the first probe holder meet.

Accordingly it is a further object of the invention to provide a solution according to which, during probe exchange operations in the SPM system, time-dependently variable values of a first gap width between the probe and the first probe holder can be measured accurately without substantially sacrificing building space of the SPM system nearby the location where the probe and the first probe holder meet.

For that purpose, in a preferable embodiment of a scanning probe microscopy system according to the invention, a probe-exchange operation condition of the scanning probe microscopy system is defined as being said probe-mounting operation condition or said probe-demounting operation condition, and wherein the scanning probe microscopy system further comprises a first gap width measuring system for measuring, in said probe-exchange operation condition, at least one value of a time-dependently variable first gap width of a first gap in-between said probe and said first probe holder,

and wherein the first gap width measuring system comprises:
a first gas flow system, which is configured, arranged and effective to control in said probe-exchange operation condition a first gas flow of a first gas by applying predetermined first gas flow excitation conditions to said first gas, wherein said first gas flow occurs at least in said first gap;
at least one first pressure sensor, which is configured, arranged and effective to sense in said probe-exchange operation condition a time-dependently variable first pressure of said first gas, wherein said sensing takes place at at least one predetermined position in a first pressure sensing flow path of said first gas flow; and
a first evaluation system, which is configured, arranged and effective to determine in said probe-exchange operation condition said at least one value of said time-dependently variable first gap width based on at least said sensed time-dependently variable first pressure of said first gas and said predetermined first gas flow excitation conditions in said probe-exchange operation condition.

Hence, this preferable embodiment of the invention requires hardly any building space of the SPM system nearby the location where the probe and the first probe holder meet. After all, nearby the location where the probe and the first probe holder meet, this preferable embodiment of the invention merely requires that a first gas may access to and flow in the first gap in-between the probe and the first probe holder. In other words, the building space requirement is more or less automatically met because, nearby the location where the probe and the first probe holder meet, the invention basically only requires the first gap, which is inherently available there.

The underlying working principle of the first gap width measuring system of the SPM system according to the invention is elucidated as follows. When a gas is flowing under predetermined gas flow excitation conditions through a gap, changing the gap width results in changing the flow resistance provided by the gap. For example, when the gap is narrowing, the gas flow speed is consequently increasing while at the same time the gas pressure is decreasing. In fact, said predetermined first gas flow excitation conditions in said probe-exchange operation condition determine a functional relationship between said first gas pressure and said first gap width as function variables, when said first gas pressure is measured at at least one predetermined position in a first pressure sensing flow path of said first gas flow. In other words, said functional relationship between said first gas pressure and said first gap width is derivable from said predetermined first gas flow excitation conditions. In that sense, said functional relationship can be said to be a-priori known for a given SPM system configuration. Accordingly, based on said a-priori known functional relationship between said first gas pressure and said first gap width, the time-dependently variable values of the first gap width can directly be derived from the sensed time-dependently variable pressure values of the first gas.

In a further preferable embodiment of the invention, said resultant force comprises said gas pressure force components, wherein the scanning probe microscopy system further comprises a first vacuum suction system for holding in said mounted-probe operation condition the probe against the first probe holder based on vacuum suction applied through a first vacuum suction flow path, wherein said first pressure sensing flow path of the first gap width measuring system and said first vacuum suction flow path of the first vacuum suction system are at least partially overlapping with one another.

Thanks to the first vacuum suction system, the first probe holder functions as a vacuum clamp. The highly synergistic integrated combination of said first gap width measuring system with the first vacuum suction system, makes the automatic probe exchange structure of the SPM system according to the invention extremely efficient in terms of speed, accuracy and building space.

In a further preferable embodiment of the invention, a probe-exchange operation condition of the scanning probe microscopy system is defined as being said probe-mounting operation condition or said probe-demounting operation condition, wherein the scanning probe microscopy system further comprises a second gap width measuring system for measuring, in said probe-exchange operation condition, at least one value of a time-dependently variable second gap width of a second gap in-between said probe and said second probe holder,

and wherein the second gap width measuring system comprises:
a second gas flow system, which is configured, arranged and effective to control in said probe-exchange operation condition a second gas flow of a second gas by applying predetermined second gas flow excitation conditions to said second gas, wherein said second gas flow occurs at least in said second gap;
at least one second pressure sensor, which is configured, arranged and effective to sense in said probe-exchange operation condition a time-dependently variable second pressure of said second gas, wherein said sensing takes place at at least one predetermined position in a second pressure sensing flow path of said second gas flow; and
a second evaluation system, which is configured, arranged and effective to determine in said probe-exchange operation condition said at least one value of said time-dependently variable second gap width based on at least said sensed time-dependently variable second pressure of said second gas and said predetermined second gas flow excitation conditions in said probe-exchange operation condition.

The underlying working principle of the second gap width measuring system is the same as the above-explained underlying working principle of the first gap width measuring system.

The second gap width measuring system provides similar advantages as explained above for the first gap width measuring system.

Furthermore the simultaneous application of both the first gap width measuring system and the second gap width measuring system in the scanning probe microscopy system enables to combine the measurements of both measuring systems during such a probe-exchange operation condition, to thereby obtain more reliable estimates of the position of the probe relative to the first probe and/or the position of the probe relative to the second probe holder, as compared to a case where only one of both measuring systems is applied in the scanning probe microscopy system.

In a further preferable embodiment of the invention, said resultant force comprises said gas pressure force components, wherein the scanning probe microscopy system further comprises a second vacuum suction system for holding in said demounted-probe operation condition the probe against the second probe holder based on vacuum suction applied through a second vacuum suction flow path, wherein said second pressure sensing flow path of the second gap width measuring system and said second vacuum suction flow path of the second vacuum suction system are at least partially overlapping with one another.

Thanks to the second vacuum suction system, the second probe holder functions as a vacuum clamp. The highly synergistic integrated combination of said second gap width measuring system with the second vacuum suction system, makes the automatic probe exchange structure of the SPM system according to the invention extremely efficient in terms of speed, accuracy and building space.

In a further preferable embodiment of the invention, the scanning probe microscopy system further comprises:
a probe storage device for storing multiple ones of said probe; and
multiple ones of said scanning head, which are configured, arranged and effective to perform, independently relative to one another, scanning movements from below along a lower surface of a sample, which is held by the scanning probe microscopy system;

and wherein the scanning probe microscopy system is configured, arranged and effective:
to further have a probe-fetching operation condition in which the probe exchange manipulator is picking-up the probe from the probe storage device; and
to allow the effectuation of a succession of said probe-fetching operation condition, said probe-mounting operation condition, and said mounted-probe operation condition, in that order, respectively, wherein during said probe-mounting operation condition and said probe-demounting operation condition the probe exchange manipulator is located above the scanning head, so that during said probe-mounting operation condition the probe is moving downwards, and during said probe-demounting operation condition the probe is moving upwards.

Hence, in this preferable embodiment the SPM system has the probe storage device and the multiple, independently moveable scanning heads, while during probe mounting the probe exchange manipulator is located above the scanning head concerned.

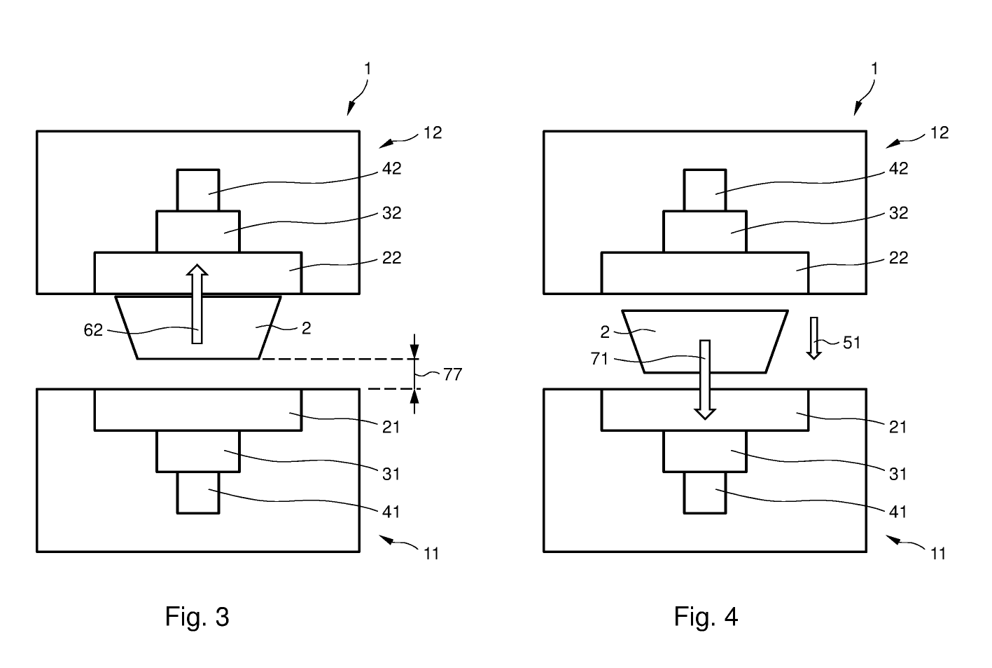

WO2014/003557A1, especially in FIGS. 2, 3A thereof, shows an example of such a special configuration in an SPM system having a probe exchange manipulator located above multiple moveable scanning heads. Said FIG. 2 of WO2014/003557A1 shows the multiple, simultaneously and independently moveable scanning heads. Said FIG. 3A shows two of these scanning heads 43, 53 having the mounted probes 45, 55, respectively, arranged for scanning along a lower surface of the sample 36, which is held by the sample carrier 35. For performing the scanning movements the scanning heads 43, 53 are moveable by the scanning arms 41, 51, respectively. The special configuration of said FIGS. 2, 3A is highly unpractical for designing the SPM system in the traditional manner in which an SPM system has only one scanning head, which is moving towards and above a probe storage device for perfoming direct probe exchange between the scanning head and the probe storage device arranged below the scanning head. For that reason, said FIG. 3A of WO2014/003557A1 further shows two probe exchange manipulators 37, which serve as intermediary between such a scanning head and such a probe storage device (not shown in said FIG. 3A). As seen in said FIG. 3A, these probe exchange manipulators 37 are at a higher vertical Z-axis position than the scanning heads 43, 53.

The present invention, according to which probes are performing their probe exchange movements in a contactless manner, provides particularly high added value in combination with the above-mentioned special configuration where a probe exchange manipulator is located above multiple scanning heads. The reason is that during probe-mounting the contactless fly-over movements of the probe can be performed with the benefit of gravity, or by gravity alone. Making use of gravity, means that the scanning heads can be designed with little or no elements of the force generating system and/or of the force control system of the SPM system therein and/or thereon. This contributes to keeping the multiple scanning heads and their movement structures simple, lightweight and compact.

In the following, the invention is further elucidated with reference to non-limiting embodiments of the invention and with reference to the schematic figures in the attached drawing, in which the following is shown.

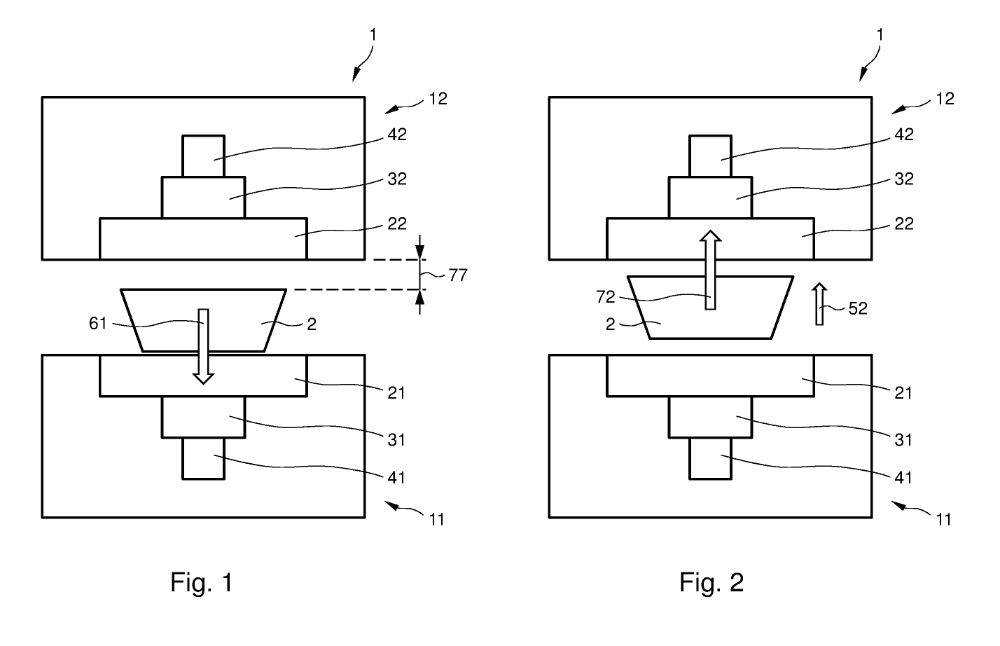

FIG. 1 shows in a cross-sectional side view an example of a first embodiment of a scanning probe microscopy system according to the invention, wherein the scanning probe microscopy system is in its mounted-probe operation condition.

FIG. 2 shows the configuration and view of FIG. 1 again, however wherein this time, starting from the situation of FIG. 1, the scanning probe microscopy system has been brought in its probe-demounting operation condition.

FIG. 3 shows the configuration and view of FIG. 2 again, however wherein this time, starting from the situation of FIG. 2, the scanning probe microscopy system has been brought in its demounted-probe operation condition.

FIG. 4 shows the configuration and view of FIG. 3 again, however wherein this time, starting from the situation of FIG. 3, the scanning probe microscopy system has been brought in its probe-mounting operation condition.

FIG. 5 shows in a cross-sectional side view an example of a second embodiment of an SPM system according to the invention, wherein the SPM system is in its probe-exchange operation condition, and wherein for simplicity the probe exchange manipulator of the SPM system is not shown.

FIG. 6 shows a functional relationship between the sensed first pressure P of the first gas and the first gap width D, to illustrate the underlying working principle of the first gap width measuring system of the SPM system of FIG. 5.

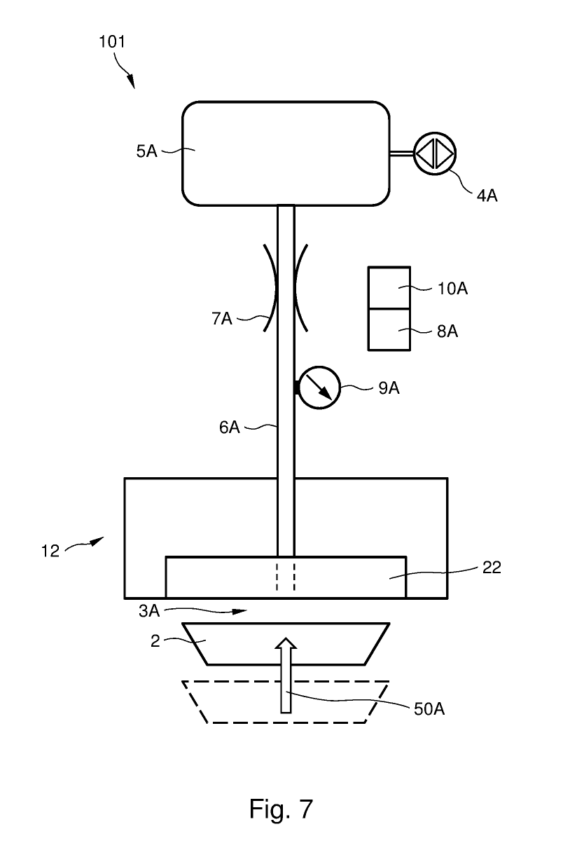

FIG. 7 separately shows at least the probe exchange manipulator of the SPM system of FIG. 5 in a cross-sectional side view similar to that of FIG. 5.

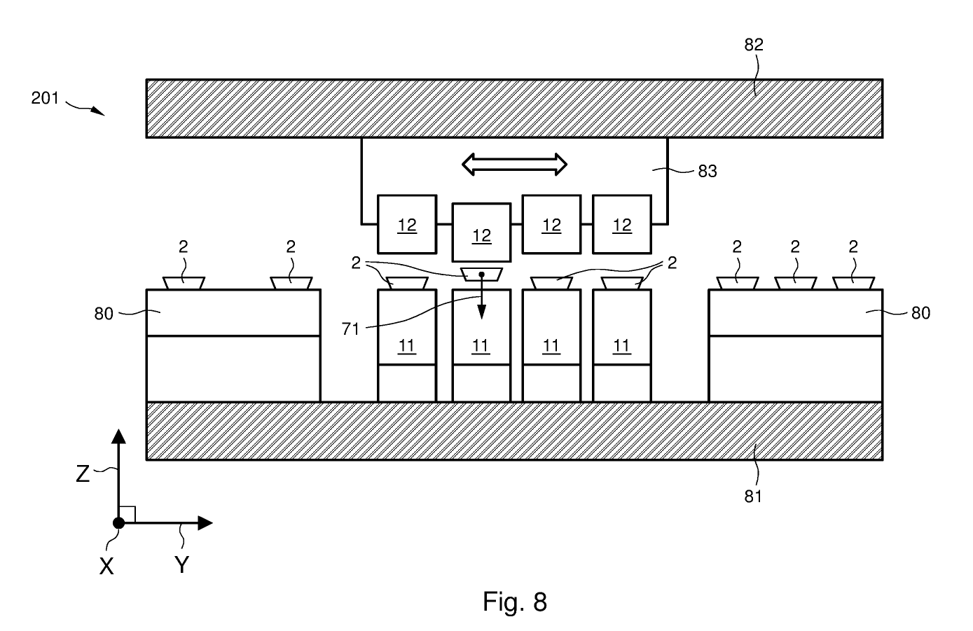

FIG. 8 shows in a cross-sectional side view an example of a third embodiment of an SPM system according to the invention, wherein the SPM system of FIG. 8 is according to the abovementioned preferable embodiment of the invention, in which the SPM system has the probe storage device and the multiple, independently moveable scanning heads, while during probe mounting the probe exchange manipulator is located above the scanning head concerned.

The reference numerals used in FIGS. 1-8 are referring to the abovementioned parts and aspects of the invention, as well as to related parts and aspects, in the following manner.

1; 101; 201 scanning probe microscopy (SPM) system

2 probe

3 first gap

3A second gap

4, 4A pump

5, 5A gas vessel

6, 6A gas conduit

7, 7A gas flow restrictor

8, 8A gas flow controller

9 first pressure sensor

9A second pressure sensor

10 first evaluation system

10A second evaluation system

11 scanning head

12 probe exchange manipulator

21 first probe holder

22 second probe holder

31, 32 force generating system

41, 42 force control system

50, 50A, 51, 52 movement of the probe

53 course along a graph

61, 62, 71, 72 resultant force acting on the probe

77 fly-over distance

80 probe storage device

81 lower frame part

82 upper frame part

83 Y-slide

D, D1, D2 first gap width

P, P1, P2 first pressure of first gas

In FIGS. 1-8 sometimes the same reference numerals have been used for parts and aspects which are alike throughout the different embodiments in FIGS. 1-8.

Based on the above introductory description, including the brief description of the figures, and based on the above-explained reference numerals used in the figures, the shown examples of FIGS. 1-8 are for the greatest part readily self-explanatory. In addition to these readily apparent self-explanations, the following extra explanations are given.

Now, reference is first made to the first embodiment of FIGS. 1-4.

In the shown example, the force generating system of the SPM system 1 comprises a first force generating unit 31 and a second force generating unit 32, which have been depicted (highly schematically) at the scanning head 11 nearby the first probe holder 21 and at the probe exchange manipulator 12 nearby the second probe holder 22, respectively. Furthermore, the force control system of the SPM system 1 comprises a first force control unit 41 and a second force control unit 42, which have been depicted (highly schematically) at the scanning head 11 nearby the first probe holder 21 and at the probe exchange manipulator 12 nearby the second probe holder 22, respectively. This has been done in order to illustrate that force generating elements and force control elements of the force generating system and the force control system of an SPM system according to the invention may in general be distributed over the scanning head and the probe exchange manipulator of the SPM system. Alternatively, however, force generating elements and force control elements of the force generating system and the force control system of an SPM system according to the invention may in general also be located at only the scanning head, at only the probe exchange manipulator, and/or at various other parts of the SPM system.

As mentioned, the resultant force provided by the force generating system may for example comprise gas pressure force components and/or electrostatic force components.

Gas pressure force components, for example, may for example be provided by (vacuum) suction elements and/or by gas blowing elements of the force generating system of the SPM system. In the shown example, each of the first force generating unit 31 and the second force generating unit 32 may for example have suction/blowing elements. For example, in the mounted-probe operation condition of FIG. 1, the resultant force 61 acting on the probe 2 may be formed by vacuum suction provided by the first force generating unit 31 under control of the first force control unit 41. Analogously, in the demounted-probe operation condition of FIG. 3, the resultant force 62 acting on the probe 2 may be formed by vacuum suction provided by the second force generating unit 32 under control of the second force control unit 42. Furthermore, in the probe-demounting operation condition of FIG. 2 the resultant force 72 acting on the probe 2 may be formed by suction forces provided by the second force generating unit 32 under control of the second force control unit 42 and/or by blowing forces provided by the first force generating unit 31 under control of the first force control unit 41. Analogously, in the probe-mounting operation condition of FIG. 4 the resultant force 71 acting on the probe 2 may be formed by suction forces provided by the first force generating unit 31 under control of the first force control unit 41 and/or by blowing forces provided by the second force generating unit 32 under control of the second force control unit 42.

More in general, this makes clear that according to the invention the resultant force provided by the force generating system may generally comprise one or more attraction forces between the probe and the first probe holder or the second probe holder, one or more repulsion forces between the probe and the first probe holder or the second probe holder, as well as combinations of these one or more attraction forces and these one or more repulsion forces. This not only holds for the gas pressure force components, as explained above, but also holds for the mentioned electrostatic force components, and for any other type of force components of the resultant force provided by the force generating system.

Next, reference is made to the second embodiment of FIGS. 5-7.

In the shown example of FIG. 5, the first gas flow system of the SPM system 101 according to the invention comprises the pump 4, the gas vessel 5, the gas conduit 6, the gas flow restrictor 7, and the gas flow controller 8. During the probe-exchange operation condition of the SPM system 101, the gas flow controller 8 may, for example, control the pump 4 to continuously pump a first gas (e.g. air, or another gas) out of the gas vessel 5, thereby maintaining in the gas vessel 5 a certain continuous underpressure of the first gas relative to the environment. This results into a continuous first gas flow, which is successively flowing through the first gap 3, via the first probe holder 21 of the scanning head 11 into the gas conduit 6, into the gas vessel 5, and via the pump 4 out of the gas vessel 5. It is noted that during the probe-exchange operation condition the gas flow controller 8 may furthermore control the gas flow restrictor 7. Accordingly, it is clear how the first gas flow system of the SPM system 101, by applying predetermined first gas flow excitation conditions to the first gas, is able to control the first gas flow in the probe-exchange operation condition, wherein that first gas flow occurs at least in the first gap 3. It is noted that the first pressure sensor 9 is arranged to sense the first pressure of the first gas at some point along the gas conduit 6, hence at some point along the abovementioned first pressure sensing flow path, which in the shown example is successively formed by the first gap 3, the first probe holder 21, the gas conduit 6, the gas vessel 5, and the pump 4.

In the situation of FIG. 5, the probe 2 is automatically controlled to move towards the first probe holder 21. This relative movement of the probe 2 has been indicated in FIG. 5 by the arrow 50. In FIG. 5 a previous position of the probe 2 during its relative movement 50 has been shown in broken lines, while the actual position of the probe 2 has been shown in full lines. In FIG. 1 it is seen that in the actual position of the probe 2 the first gap width D of the first gap 3 has the value D1, while in said previous position of the probe 2 the first gap width D has the value D2.

FIG. 6 shows, in relation to the example of FIG. 5, a graph of the functional relationship between the sensed first pressure P and the first gap width D as function variables. Therein, the sensed first pressure P refers to the pressure of the first gas sensed by the first pressure sensor 9. It is noted that in FIG. 5 the letter O refers to the origin of the (D, P) axes system, which means that at this origin O both the first gap width D and the sensed first pressure P are zero.

The functional relationship of FIG. 6 is predetermined by the predetermined first gas flow excitation conditions imposed by the first gas flow controller 8. That is, the functional relationship of FIG. 6 is predetermined by how exactly the gas flow controller 8 controls the pump 4 and the gas flow restrictor 7. In that sense, said functional relationship can be said to be a-priori known for certain given first gas flow excitation conditions imposed by the gas flow controller 8 for the given configuration of the SPM system 101. A-priori known characteristics of said a-priori known functional relationship can for example be acquired by performing calibrating operations in advance for said certain given first gas flow excitation conditions for said given configuration of the SPM system 101.

Accordingly, based on a-priori known characteristics of said functional relationship between the first pressure P and the first gap width D as shown in FIG. 6, the time-dependently variable values of the first gap width can, during a probe-exchange operation condition of the SPM system 101, directly and immediately be derived from the sensed time-dependently variable first pressure values of the first gas. In the example of FIG. 6 it is seen that the specific first gap width values D1 and D2 are derived from the first pressure values P1 and P2, respectively, sensed by the first pressure sensor 9. The arrow 53 in FIG. 6 shows the course along the graph of FIG. 6, which course corresponds to the movement of the probe 2 according to the arrow 50 in FIG. 1.

The SPM system 101 furthermore is an example of the abovementioned preferable embodiment of a scanning probe microscopy system according to the invention, wherein said resultant force comprises said gas pressure force components, and wherein the scanning probe microscopy system further comprises a first vacuum suction system for holding, in said mounted-probe operation condition of the scanning probe microscopy system, the probe against the first probe holder based on vacuum suction applied through a first vacuum suction flow path, wherein said first pressure sensing flow path of the first gap width measuring system and said first vacuum suction flow path of the first vacuum suction system are at least partially overlapping with one another.

That is, in the SPM system 101, the first probe holder 21 functions as a vacuum clamp for holding the probe 2 against the first probe holder 21 based on vacuum suction applied through said first vacuum suction flow path. In fact, in the shown example, both the first vacuum suction system and the first gas flow system comprise the same elements, i.e. the pump 4, the gas vessel 5, the gas conduit 6, the gas flow restrictor 7, and the gas flow controller 8. Furthermore, the first pressure sensing flow path of the first gap width measuring system and the first vacuum suction flow path of the first vacuum suction system have the first probe holder 21, the gas conduit 6, the gas vessel 5, and the pump 4 as mutually overlapping parts.

The integrated combination of the first gap width measuring system and the first vacuum system, makes the SPM system 101 extremely efficient in terms of speed, accuracy and building space. For example, when in the probe-exchange operation condition of FIG. 5, during the movements 50 of the probe 2 relative to the first probe holder 21 a lower threshold value of the first gap width D has been measured by the first gap width measuring system, the gas flow controller 8 can then immediately switch to a different control mode, which is suitable for holding, in the mounted-probe operation condition of the scanning probe microscopy system, the probe 2 against the first probe holder 21 based on vacuum suction applied through the first vacuum suction flow path.

FIG. 7 shows the probe exchange manipulator 12 of the SPM system 101 of FIG. 5. In the situation of FIG. 7, the probe 2 is automatically controlled to move towards the second probe holder 22 of the probe exchange manipulator 12. This relative movement of the probe 2 has been indicated in FIG. 7 by the arrow 50A. FIG. 7 serves to illustrate the abovementioned preferable embodiments of the invention, wherein the SPM system according to the invention has the abovementioned second gap width measuring system, as well as the abovementioned second vacuum suction system. It is seen that the configuration of FIG. 7 has high similarity with the configuration of FIG. 5. In FIG. 7 the structure and underlying working principles of the second gap width measuring system and the second vacuum suction system are the same as the structure and underlying working principles of the first gap width measuring system and the first vacuum suction system of FIG. 5. Accordingly, some parts and aspects in FIG. 7, which relate to the second gap width measuring system and the second vacuum suction system, and which are alike to corresponding parts and aspects in FIG. 5 relating to the first gap width measuring system and the first vacuum suction system, have been indicated by the same reference numerals, but with the letter “A” appended thereto. Thus, in FIG. 7 the reference numerals 4A, 5A, 6A, 7A, 8A indicate a pump, a gas vessel, a gas conduit, a gas flow restrictor, a gas flow controller, respectively, while the reference numerals 3A, 9A, 10A indicate the second gap, the second pressure sensor and the second evaluation system, respectively.

Next, reference is made to the third embodiment of FIG. 8, which shows the SPM system 201 in a YZ-plane of an orthogonal XYZ-axes system, in which the Z-axis is the vertical direction. The SPM system 201 has the lower frame part 81 and the upper frame part 82, which in operation are arranged in an immoveable manner relative to the environment in which the SPM system 201 is placed. FIG. 8 shows the two probe storage devices 80 of the SPM system 201. These probe storage devices 80 are fixedly attached relative to the lower frame part 81. FIG. 8 further shows the four scanning heads 11 and the four probe exchange manipulators 12 of the SPM system 201. The four probe exchange manipulators 12 are suspended from the Y-slide 83, which is suspended from the upper frame part 82 in a slidable manner along the Y-axis. In the shown situation the four scanning heads 11 and the four probe exchange manipulators 12 are standing still relative to the lower and upper frame parts 81, 82. Thanks to the Y-slide 83 each probe exchange manipulator 12 is able to pick-up a new probe 2 from one of the probe storage devices 80, to bring this probe towards a scanning head 11, and to mount the probe 2 to that scanning head 11. Also the probe exchange manipulator 12 is able to pick-up an old probe 2 from the scanning head 11 and to bring the old probe 2 towards a waste location.

FIG. 8 shows a number of probes 2. Five of the shown probes 2 are stored in the two probe storage devices 80. Three of the shown probes 2 are being held by three scanning heads 11, respectively. For these three probes 2 the mounted-probe operation condition is effective.

For the remaining one of the shown probes 2 the probe-mounting operation condition is effective, wherein this one probe 2 is moving downwards from the probe exchange manipulator 12 concerned towards the scanning head 11 concerned. This is comparable to the situation of FIG. 4, and therefore in FIG. 8 the resultant force acting on this one probe 2 has been indicated by the same reference numeral 71 as used in FIG. 4. The shown contactless fly-over movement of this one probe 12 is performed with the benefit of gravity. Thanks to this use of gravity, the scanning heads 11 can be designed with little or no elements of the force generating system anchor of the force control system of the SPM system 201 therein anchor thereon. This contributes to keeping the multiple scanning heads 11 and their movement structures simple, lightweight and compact.

While the invention has been described and illustrated in detail in the foregoing description and in the drawing figures, such description and illustration are to be considered exemplary and/or illustrative and not restrictive; the invention is not limited to the disclosed embodiments.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. For example, it has been specified above that according to the invention said resultant force, which is provided by the force generating system under control of the force control system, comprises gas pressure force components and/or electrostatic force components. This does not exclude that said resultant force, which is provided by the force generating system under control of the force control system, optionally may additionally comprise magnetic induction force components.

Furthermore, a single processor or other unit may fulfil the functions of several items recited in the claims. For the purpose of clarity and a concise description, features are disclosed herein as part of the same or separate embodiments, however, it will be appreciated that the scope of the invention may include embodiments having combinations of all or some of the features disclosed. The mere fact that certain measures are recited in mutually different dependent claims does not indicate that a combination of these measures can not be used to advantage. Any reference signs in the claims should not be construed as limiting the scope.

1. A scanning probe microscopy system, comprising a probe, a scanning head having a first probe holder, a probe exchange manipulator having a second probe holder, a force generating system, and a force control system for controlling the force generating system to provide a resultant force acting on the probe in the direction of the first probe holder or in the direction of the second probe holder,
wherein the probe exchange manipulator and the scanning head are movable towards and away from one another,
and wherein the scanning probe microscopy system is configured, arranged and effective to have:
a mounted-probe operation condition in which the probe is held against the first probe holder in that said force control system is controlling said resultant force to act on the probe in the direction of the first probe holder, while the probe is not contacting the second probe holder;
a demounted-probe operation condition in which the probe is held against the second probe holder in that said force control system is controlling said resultant force to act on the probe in the direction of the second probe holder, while the probe is not contacting the first probe holder;
a probe-demounting operation condition in which the scanning probe microscopy system is switching from its mounted-probe operation condition to its demounted-probe operation condition in that the probe is moving from the first probe holder towards the second probe holder, while neither the first probe holder nor the second probe holder is contacting the probe, wherein said movement of the probe from the first probe holder towards the second probe holder is driven by said resultant force acting on the probe in the direction of the second probe holder under control of said force control system; and
a probe-mounting operation condition in which the scanning probe microscopy system is switching from its demounted-probe operation condition to its mounted-probe operation condition in that the probe is moving from the second probe holder towards the first probe holder, while neither the first probe holder nor the second probe holder is contacting the probe, wherein said movement of the probe from the second probe holder towards the first probe holder is driven by said resultant force acting on the probe in the direction of the first probe holder under control of said force control system,
and wherein said resultant force comprises gas pressure force components and/or electrostatic force components.

2. A scanning probe microscopy system according to claim 1, wherein a probe-exchange operation condition of the scanning probe microscopy system is defined as being said probe-mounting operation condition or said probe-demounting operation condition, and wherein the scanning probe microscopy system further comprises a first gap width measuring system for measuring, in said probe-exchange operation condition, at least one value of a time-dependently variable first gap width of a first gap in-between said probe and said first probe holder,
and wherein the first gap width measuring system comprises:
a first gas flow system, which is configured, arranged and effective to control in said probe-exchange operation condition a first gas flow of a first gas by applying predetermined first gas flow excitation conditions to said first gas, wherein said first gas flow occurs at least in said first gap;
at least one first pressure sensor, which is configured, arranged and effective to sense in said probe-exchange operation condition a time-dependently variable first pressure of said first gas, wherein said sensing takes place at at least one predetermined position in a first pressure sensing flow path of said first gas flow; and
a first evaluation system, which is configured, arranged and effective to determine in said probe-exchange operation condition said at least one value of said time-dependently variable first gap width based on at least said sensed time-dependently variable first pressure of said first gas and said predetermined first gas flow excitation conditions in said probe-exchange operation condition.

3. A scanning probe microscopy system according to claim 2, wherein said resultant force comprises said gas pressure force components, and wherein the scanning probe microscopy system further comprises a first vacuum suction system for holding in said mounted-probe operation condition the probe against the first probe holder based on vacuum suction applied through a first vacuum suction flow path, wherein said first pressure sensing flow path of the first gap width measuring system and said first vacuum suction flow path of the first vacuum suction system are at least partially overlapping with one another.

4. A scanning probe microscopy system according to claim 1, wherein a probe-exchange operation condition of the scanning probe microscopy system is defined as being said probe-mounting operation condition or said probe-demounting operation condition, and wherein the scanning probe microscopy system further comprises a second gap width measuring system for measuring, in said probe-exchange operation condition, at least one value of a time-dependently variable second gap width of a second gap in-between said probe and said second probe holder,
and wherein the second gap width measuring system comprises:
a second gas flow system, which is configured, arranged and effective to control in said probe-exchange operation condition a second gas flow of a second gas by applying predetermined second gas flow excitation conditions to said second gas, wherein said second gas flow occurs at least in said second;
at least one second pressure sensor, which is configured, arranged and effective to sense in said probe-exchange operation condition a time-dependently variable second pressure of said second gas, wherein said sensing takes place at at least one predetermined position in a second pressure sensing flow path of said second gas flow; and
a second evaluation system, which is configured, arranged and effective to determine in said probe-exchange operation condition said at least one value of said time-dependently variable second gap width based on at least said sensed time-dependently variable second pressure of said second gas and said predetermined second gas flow excitation conditions in said probe-exchange operation condition.

5. A scanning probe microscopy system according to claim 4, wherein said resultant force comprises said gas pressure force components, and wherein the scanning probe microscopy system further comprises a second vacuum suction system for holding in said demounted-probe operation condition the probe against the second probe holder based on vacuum suction applied through a second vacuum suction flow path, wherein said second pressure sensing flow path of the second gap width measuring system and said second vacuum suction flow path of the second vacuum suction system are at least partially overlapping with one another.

6. A scanning probe microscopy system according to claim 1, further comprising:
a probe storage device for storing multiple ones of said probe; and
multiple ones of said scanning head, which are configured, arranged and effective to perform, independently relative to one another, scanning movements from below along a lower surface of a sample, which is held by the scanning probe microscopy system;
and wherein the scanning probe microscopy system is configured, arranged and effective:
to further have a probe-fetching operation condition in which the probe exchange manipulator is picking-up the probe from the probe storage device; and
to allow the effectuation of a succession of said probe-fetching operation condition, said probe-mounting operation condition, and said mounted-probe operation condition, in that order, respectively, wherein during said probe-mounting operation condition and said probe-demounting operation condition the probe exchange manipulator is located above the scanning head, so that during said probe-mounting operation condition the probe is moving downwards, and during said probe-demounting operation condition the probe is moving upwards.

7. A method for mounting and demounting a probe in a scanning probe microscopy system, wherein the scanning probe microscopy system comprises a probe, a scanning head having a first probe holder, a probe exchange manipulator having a second probe holder, a force generating system, and a force control system for controlling the force generating system to provide a resultant force acting on the probe in the direction of the first probe holder or in the direction of the second probe holder, wherein the probe exchange manipulator and the scanning head are movable towards and away from one another, and wherein the scanning probe microscopy system is configured, arranged and effective to have a mounted-probe operation condition, a demounted-probe operation condition, a probe-demounting operation condition, and a probe-mounting operation condition, and wherein:
in said mounted-probe operation condition, the probe is held against the first probe holder in that said force control system is controlling said resultant force to act on the probe in the direction of the first probe holder, while the probe is not contacting the second probe holder;
in said demounted-probe operation condition, the probe is held against the second probe holder in that said force control system is controlling said resultant force to act on the probe in the direction of the second probe holder, while the probe is not contacting the first probe holder;
in said probe-demounting operation condition, the scanning probe microscopy system is switching from its mounted-probe operation condition to its demounted-probe operation condition in that the probe is moving from the first probe holder towards the second probe holder, while neither the first probe holder nor the second probe holder is contacting the probe, wherein said movement of the probe from the first probe holder towards the second probe holder is driven by said resultant force acting on the probe in the direction of the second probe holder under control of said force control system; and
in said probe-mounting operation condition, the scanning probe microscopy system is switching from its demounted-probe operation condition to its mounted-probe operation condition in that the probe is moving from the second probe holder towards the first probe holder, while neither the first probe holder nor the second probe holder is contacting the probe, wherein said movement of the probe from the second probe holder towards the first probe holder is driven by said resultant force acting on the probe in the direction of the first probe holder under control of said force control system,
and wherein said resultant force comprises gas pressure force components and/or electrostatic force components.

8. A method according to claim 7, wherein a probe-exchange operation condition of the scanning probe microscopy system is defined as being said probe-mounting operation condition or said probe-demounting operation condition, and wherein in said probe-exchange operation condition at least one value of a time-dependently variable first gap width of a first gap in-between said probe and said first probe holder is measured by a first gap width measuring system of the scanning probe microscopy system,
and wherein the first gap width measuring system comprises:
a first gas flow system, which is configured, arranged and effective to control in said probe-exchange operation condition a first gas flow of a first gas by applying predetermined first gas flow excitation conditions to said first gas, wherein said first gas flow occurs at least in said first gap;
at least one first pressure sensor, which is configured, arranged and effective to sense in said probe-exchange operation condition a time-dependently variable first pressure of said first gas, wherein said sensing takes place at at least one predetermined position in a first pressure sensing flow path of said first gas flow; and
a first evaluation system, which is configured, arranged and effective to determine in said probe-exchange operation condition said at least one value of said time-dependently variable first gap width based on at least said sensed time-dependently variable first pressure of said first gas and said predetermined first gas flow excitation conditions in said probe-exchange operation condition.

9. A method according to claim 8, wherein said resultant force comprises said gas pressure force components, and wherein in said mounted-probe operation condition the probe is held against the first probe holder based on vacuum suction applied by a first vacuum suction system of the scanning probe microscopy system through a first vacuum suction flow path, wherein said first pressure sensing flow path of the first gap width measuring system and said first vacuum suction flow path of the first vacuum suction system are at least partially overlapping with one another.

10. A method according to claim 1, wherein a probe-exchange operation condition of the scanning probe microscopy system is defined as being said probe-mounting operation condition or said probe-demounting operation condition, and wherein in said probe-exchange operation condition at least one value of a time-dependently variable second gap width of a second gap in-between said probe and said second probe holder is measured by a second gap width measuring system of the scanning probe microscopy system,
and wherein the second gap width measuring system comprises:
a second gas flow system, which is configured, arranged and effective to control in said probe-exchange operation condition a second gas flow of a second gas by applying predetermined second gas flow excitation conditions to said second gas, wherein said second gas flow occurs at least in said second gap;
at least one second pressure sensor, which is configured, arranged and effective to sense in said probe-exchange operation condition a time-dependently variable second pressure of said second gas, wherein said sensing takes place at at least one predetermined position in a second pressure sensing flow path of said second gas flow; and
a second evaluation system, which is configured, arranged and effective to determine in said probe-exchange operation condition said at least one value of said time-dependently variable second gap width based on at least said sensed time-dependently variable second pressure of said second gas and said predetermined second gas flow excitation conditions in said probe-exchange operation condition.

11. A method according to claim 10, wherein said resultant force comprises said gas pressure force components, and wherein the probe is held against the second probe holder based on vacuum suction applied by a second vacuum suction system of the scanning probe microscopy system in said demounted-probe operation condition through a second vacuum suction flow path, wherein said second pressure sensing flow path of the second gap width measuring system and said second vacuum suction flow path of the second vacuum suction system are at least partially overlapping with one another.

12. A method according to claim 7, wherein the scanning probe microscopy system further comprises:
a probe storage device for storing multiple ones of said probe; and
multiple ones of said scanning head, which are configured, arranged and effective to perform, independently relative to one another, scanning movements from below along a lower surface of a sample, which is held by the scanning probe microscopy system;
and wherein the scanning probe microscopy system is configured, arranged and effective to further have a probe-fetching operation condition in which the probe exchange manipulator is picking-up the probe from the probe storage device;
and wherein a succession of said probe-fetching operation condition, said probe-mounting operation condition, and said mounted-probe operation condition is effectuated in that order, respectively, wherein during said probe-mounting operation condition and said probe-demounting operation condition the probe exchange manipulator is located above the scanning head, so that during said probe-mounting operation condition the probe is moving downwards, and during said probe-demounting operation condition the probe is moving upwards.
